(19) United States
(12) Patent Application Publication
(10) Pub. No.: US 2026/0246185 A1
(43) Pub. Date: Aug. 20, 2026

(54) STACKED CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tomohiro MAN, Mie (JP); Teruo HARA, Mie (JP); Shunya TAKEUCHI, Mie (JP)

(21) Appl. No.: 18/870,395

(22) PCT Filed: May 15, 2023
(86) PCT No.: PCT/JP2023/018090

§ 371 Date: Nov. 28, 2024

(30) Foreign Application Priority Data
May 31, 2022 (JP) 2022-088262

(51) Int. Cl. H01R 13/424; H01R 13/506

(52) U.S. Cl. CPC H01R 13/424; H01R 13/506

(57) ABSTRACT

A stacked connector includes a plurality of terminals, at least one first member and at least one second member to be stacked on the first member from one side in a first direction. The first member includes a plurality of terminal accommodating portions for accommodating the terminals. The second member includes a base portion, a plurality of locking projections projecting from the base portion toward the other side in the first direction and at least one coupling portion coupling the adjacent locking projections. The terminal includes a locking portion to be locked to the locking projection from one side in a second direction. The coupling portion projects further toward the other side in the first direction than an end part of the locking portion on the one side in the first direction.

### TECHNICAL FIELD

The present disclosure relates to a stacked connector.

### BACKGROUND

Conventionally, a connector described in Japanese Patent Laid-Open Publication No. 2012-186001 (Patent Document 1 below) is known as a stacked connector assembled by stacking a plurality of members. This connector is provided with housings including terminal accommodating portions for accommodating terminal fittings and a retainer including projections for locking the terminal fittings with the retainer overlapped on the housing. Further, the housing is stacked on another housing and includes projections similarly to the retainer.

### PRIOR ART DOCUMENT

### Patent Document

Patent Document 1: JP 2012-186001 A

### SUMMARY OF THE INVENTION

### Problems to Be Solved

In the above configuration, spaces are provided between the projections adjacent in an arrangement direction of the terminal fittings. The housing includes convex members for taking up parts of the spaces between the projections, but spaces where the convex members are not disposed still remain between the projections.

In the above configuration, for example, if a load is applied to the projection from the terminal fitting such as when a wire connected to the terminal fitting is pulled rearward of the connector, the projection is pushed out laterally to the terminal fitting while being pushed and dented by the terminal fitting. That is, a part of a material constituting the projection escapes to the space between the projections. Thus, a shear area of the projection sheared by the terminal fitting may possibly become small.

### Means to Solve the Problem

The present disclosure is directed to a stacked connector with a plurality of terminals, at least one first member and at least one second member to be stacked on the first member from one side in a first direction, the first member including a plurality of terminal accommodating portions for accommodating the terminals, the second member including a base portion, a plurality of locking projections projecting from the base portion toward the other side in the first direction and at least one coupling portion coupling the adjacent locking projections, the terminal including a locking portion to be locked to the locking projection from one side in a second direction, and the coupling portion projecting further toward the other side in the first direction than an end part of the locking portion on the one side in the first direction.

### Effect of the Invention

According to the present disclosure, it is possible to provide a technique for enhancing a terminal holding force in a stacked connector.

### BRIEF DESCRIPTION OF THE DRAWINGS

FIG. 1 is a perspective view of a stacked connector according to an embodiment.

FIG. 2 is an exploded perspective view of the stacked connector.

FIG. 3 is a back view of the stacked connector.

FIG. 4 is a front view of the stacked connector.

FIG. 5 is a section along A-A of FIG. 4.

FIG. 6 is a section along B-B of FIG. 4.

FIG. 7 is a section along C-C of FIG. 6.

FIG. 8 is a section along D-D of FIG. 7.

FIG. 9 is a perspective view of a lower housing.

FIG. 10 is an enlarged perspective view of a third member.

FIG. 11 is a perspective view of a middle housing when viewed from below.

FIG. 12 is an enlarged perspective view of a second member.

FIG. 13 is a perspective view of the middle housing when viewed from above.

FIG. 14 is a perspective view of an upper housing.

FIG. 15 is a diagram showing a creepage distance between terminals in a cross-section along D-D of FIG. 7.

FIG. 16 is a diagram showing a creepage distance between the terminals in a cross-section along E-E of FIG. 7.

FIG. 17 is a diagram showing a creepage distance between the terminals in the cross-section along D-D of FIG. 7 when a coupling portion is not provided with a groove portion.

### DETAILED DESCRIPTION TO EXECUTE THE INVENTION

### Description of Embodiments of Present Disclosure

First, embodiments of the present disclosure are listed and described.

(1) The stacked connector of the present disclosure is provided with a plurality of terminals, at least one first member and at least one second member to be stacked on the first member from one side in a first direction, the first member including a plurality of terminal accommodating portions for accommodating the terminals, the second member including a base portion, a plurality of locking projections projecting from the base portion toward the other side in the first direction and at least one coupling portion coupling the adjacent locking projections, the terminal including a locking portion to be locked to the locking projection from one side in a second direction, and the coupling portion projecting further toward the other side in the first direction than an end part of the locking portion on the one side in the first direction.

If a load is applied to the locking projection by the locking portion of the terminal, the locking projection is deformed and a part of a material of the locking projection escapes in an arrangement direction of the terminals. In the above configuration, the coupling portion is provided to couple the adjacent locking projections and projects further toward the other side in the first direction than the end part of the locking portion on the one side in the first direction. Thus, it is suppressed that a part of the material of the locking projection pushed out by the locking portion escapes in the arrangement direction of the terminals. Therefore, a shear area of the locking projection is easily ensured and a holding force for holding the terminal can be enhanced.

(2) Preferably, the coupling portion includes a groove portion recessed toward the one side in the first direction from the coupling portion, and the first member includes a protrusion disposed between the adjacent terminal accommodating portions and to be accommodated into the groove portion.

According to this configuration, a creepage distance between the terminals can be increased by providing the groove portion in the coupling portion and providing the protrusion on the first direction.

(3) Preferably, the groove portion extends in a direction intersecting the second direction.

According to this configuration, the first and second members hardly deviate in the second direction by locking the protrusion and the inner wall of the groove portion.

(4) Preferably, the second member includes a plurality of the coupling portions, and each coupling portion is provided with the groove portion extending in the same direction.

According to this configuration, intervals between the groove portions in the arrangement direction of the terminals can be set constant. Thus, the sizes of the coupling portions supporting the respective locking projections at a height where the groove portions are provided can be set constant between the plurality of locking projections. Therefore, terminal holding forces by the respective locking projections can be set equal.

(5) Preferably, the second member includes a receiving space between the adjacent locking projections, the receiving space is disposed further toward the one side in the second direction than the coupling portion, and the first member includes a projecting portion disposed between the adjacent terminal accommodating portions to enter the receiving space.

Since a height of the terminal is large near a locking surface of the locking projection to be locked to the locking portion of the terminal, a creepage distance between the adjacent terminals tends to decrease. According to this configuration, since the receiving space is disposed further toward the one side in the second direction than the coupling portion and the first member includes the projecting portion configured to enter the receiving space, the creepage distance between the terminals is easily ensured in a region near the locking surface.

(6) Preferably, a plurality of the first members and a plurality of the second members are provided, and at least one third member configured by integrating the first member and the second member is provided.

According to this configuration, since the third member doubles as the first and second members, a multi-stage stacked connector can be configured.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### EMBODIMENT

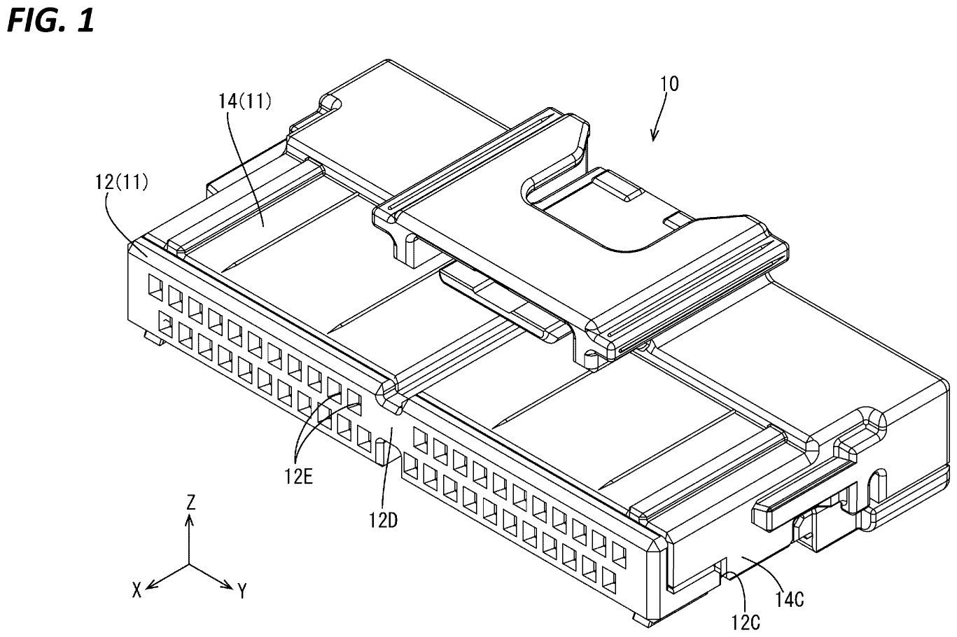

The embodiment of the present disclosure is described using FIGS. 1 to 17. In the following description, a direction indicted by an arrow Z is referred to as an upward direction, a direction indicted by an arrow X is referred to as a forward direction and a direction indicted by an arrow Y is referred to as a leftward direction. In this embodiment, an upper side is an example of one side in a first direction, and a lower side is an example of the other side in the first direction. A front side is an example of one side in a second direction. Note that, for a plurality of identical members, only some members may be denoted by a reference sign and the other members may not be denoted by the reference sign

### Stacked Connector

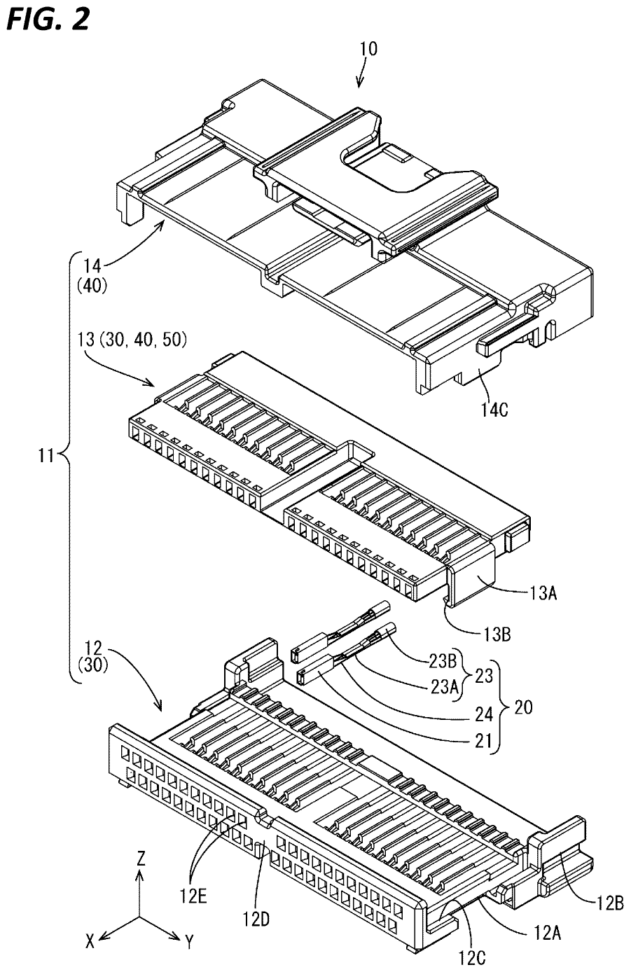

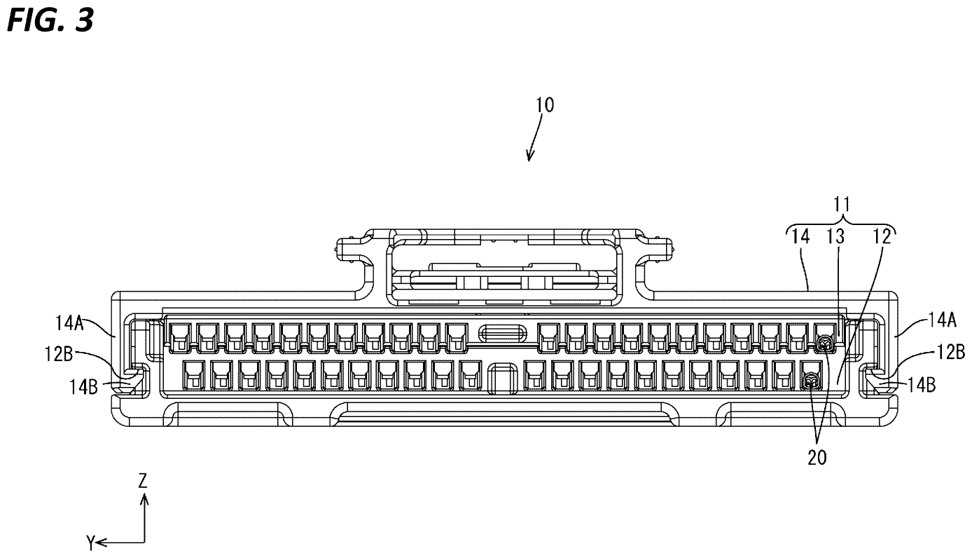

A stacked connector 10 according to this embodiment is, as shown in FIGS. 2 and 3, provided with a plurality of terminals 20 and a housing 11 for accommodating the plurality of terminals 20. The housing 11 is composed of a lower housing 12, a middle housing 13 and an upper housing 14.

### Terminal

The terminal 20 is formed, such as by press-working an electrically conductive metal plate material. As shown in FIG. 2, the terminal 20 includes a connecting tube portion 21 in the form of a rectangular tube disposed in a front part, a wire connecting portion 23 disposed behind the connecting tube portion 21 and a neck portion 24 connecting the connecting tube portion 21 and the wire connecting portion 23. The wire connecting portion 23 is a part for connecting an unillustrated wire and the terminal 20. The wire connecting portion 23 includes a wire barrel 23A to be crimped to a core wire of the wire and an insulation barrel 23B to be crimped to an insulation coating of the wire.

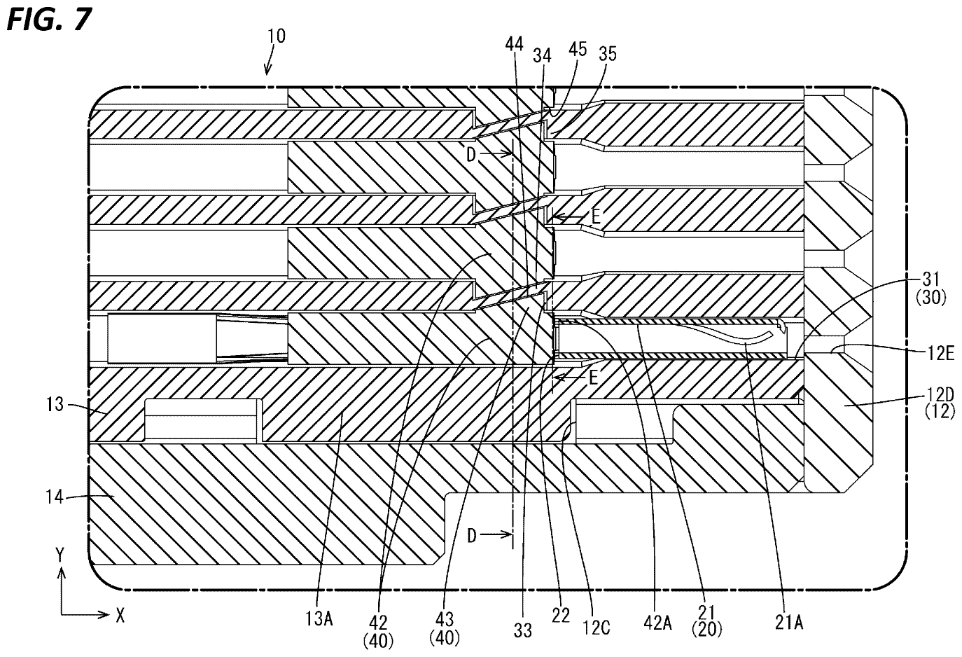

As shown in FIG. 7, a resilient contact piece 21A is provided inside the connecting tube portion 21. A mating terminal (not shown) having entered the connecting tube portion 21 contacts the resilient contact piece 21A, whereby the terminal 20 and the mating terminal are connected.

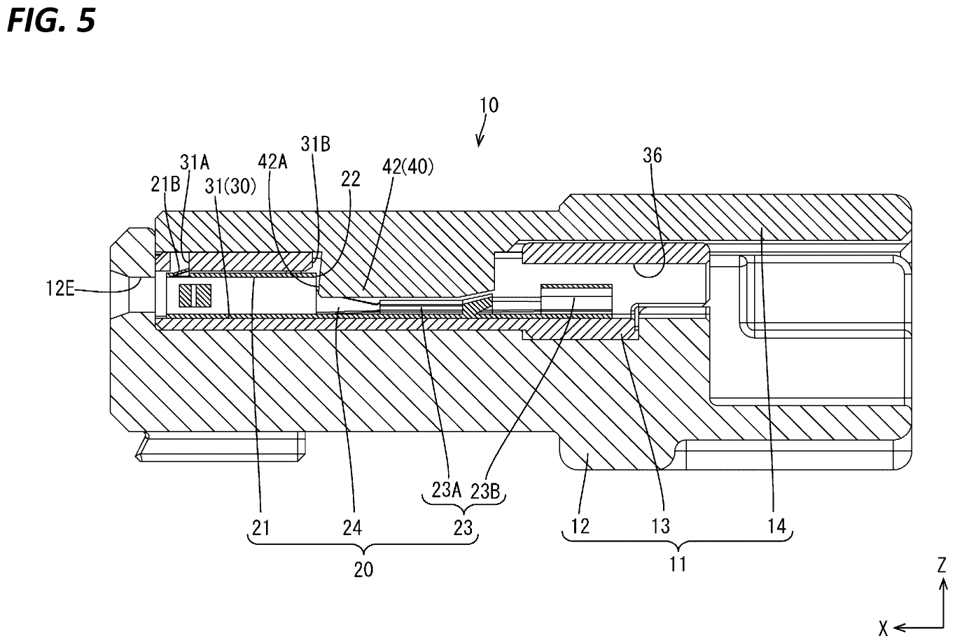

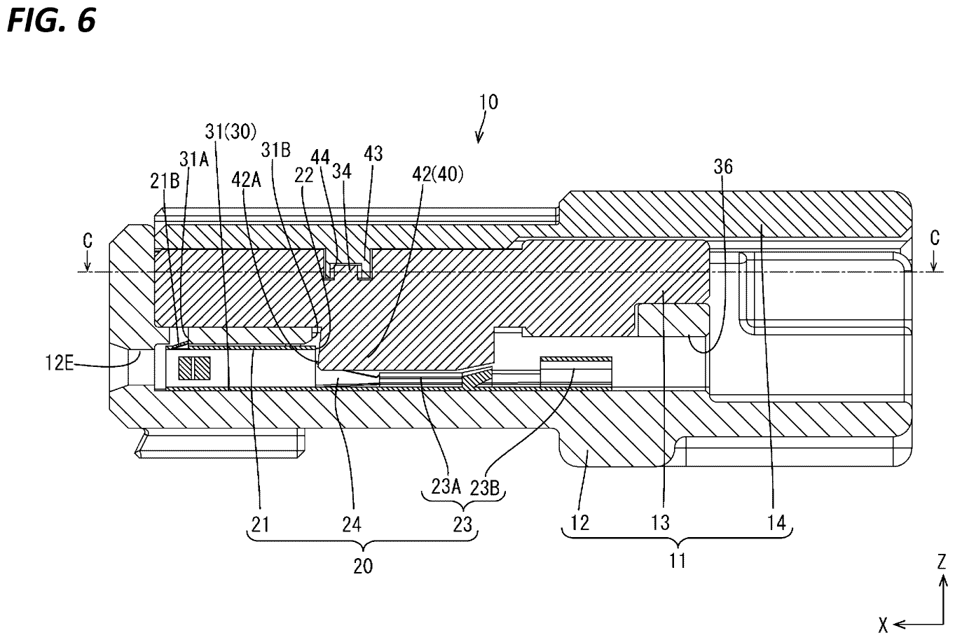

As shown in FIGS. 5 and 6, a locking lance 21B projecting upward from an upper wall is provided at a position near the front end of the upper wall of the connecting tube portion 21. The locking lance 21B is locked to the inner wall of a lance hole 31A of a terminal accommodating portion 31 to be described later. An upper part of the rear end of the connecting tube portion 21 serves as a locking portion 22. As described later, the locking portion 22 is locked to a locking projection 42 of a second member 40 from front.

As shown in FIG. 2, the lower housing 12, the middle housing 13 and the upper housing 14 are made of insulating synthetic resin and substantially in the form of plates flat in a vertical direction. The middle housing 13 is stacked on the lower housing 12 from above. The upper housing 14 is stacked on the middle housing 13 stacked on the lower housing 12 from above.

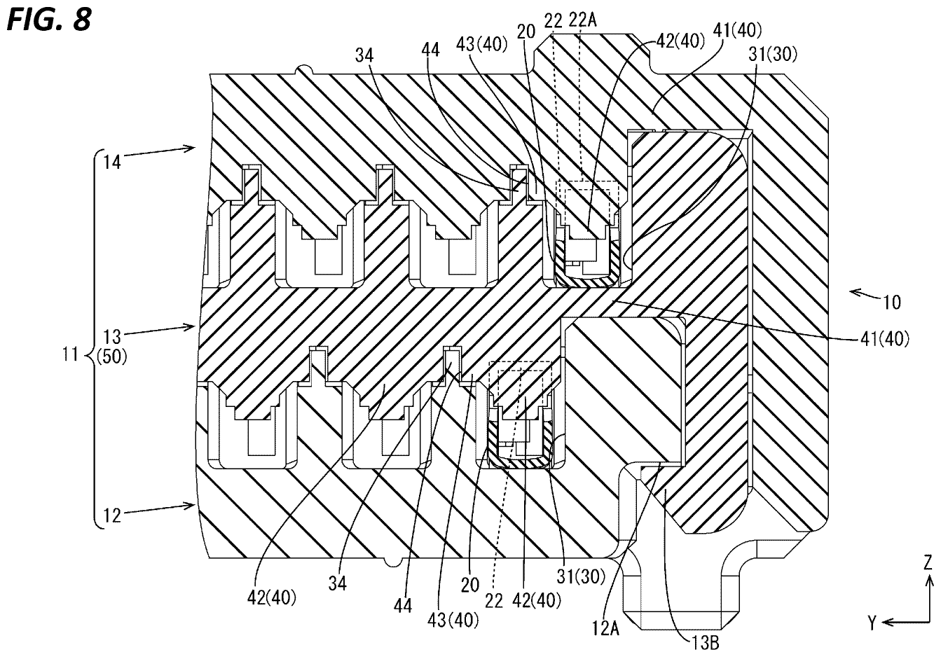

Side walls of the lower housing 12 are provided with first lock receiving portions 12A, second lock receiving portions 12B and lock recesses 12C by being recessed from the outer surfaces of the side walls. Side parts of the middle housing 13 are provided with first lock portions 13B on tip parts of resilient pieces 13A extending downward. As shown in FIG. 8, the first lock receiving portion 12A and the first lock portion 13B are locked in the vertical direction.

As shown in FIG. 3, side parts of rear sides of the upper housings 14 are provided with second lock portions 14B on tip parts of resilient pieces 14A extending downward from the upper wall of the upper housing 14. The second lock receiving portion 12B and the second lock portion 14B are locked in the vertical direction.

As shown in FIG. 1, side walls of the upper housings 14 are provided with lock protrusions 14C convex downward. The lock protrusion 14C is locked to the inner wall of the lock recess 12C in a front-rear direction. Further, as shown in FIG. 7, the resilient piece 13A of the middle housing 13 is also locked to the inner wall of the lock recess 12C in the front-rear direction.

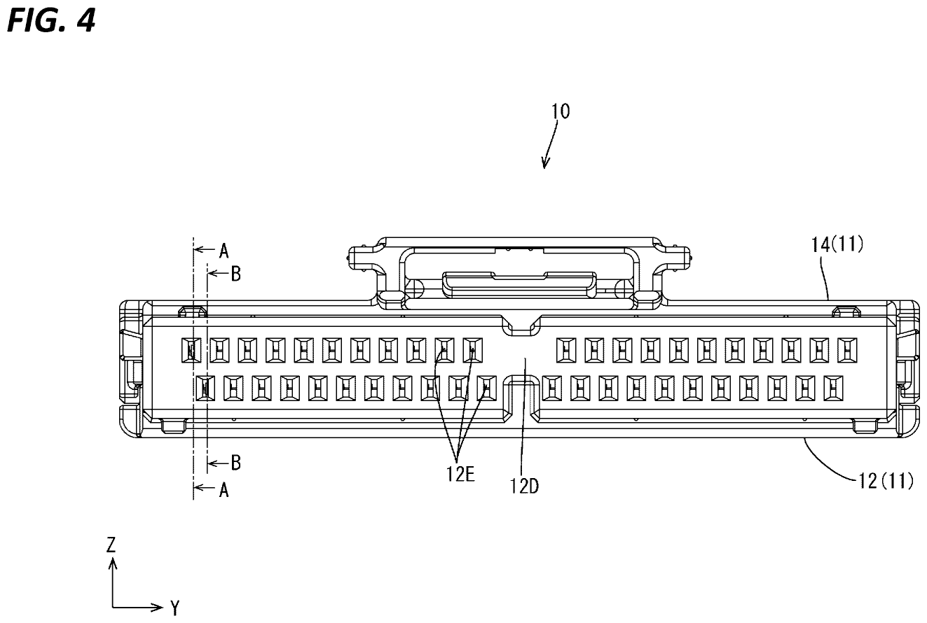

As shown in FIGS. 2 and 4, a front end part of the lower housing 12 is provided with a front wall 12D extending in the vertical direction. The front wall 12D is provided with through holes 12E penetrating through the front wall 12D in the front-rear direction. As shown in FIG. 7, the front wall 12D comes into contact with a front end part of the middle housing 13 and a front end part of the upper housing 14 from front. The through holes 12E communicate with the terminal accommodating portions 31 to be described later. Mating terminals (not shown) of a mating connector to be connected to the stacked connector 10 from front are inserted into the through holes 12E.

As shown in FIGS. 2 and 8, the housing 11 is provided with a first member 30 and a second member 40 serving as partial structures for holding the terminals 20. By stacking the second member 40 on the first member 30 accommodating the terminals 20 from above, the terminals 20 are held in the housing 11. The lower housing 12 is provided with the first member 30. The upper housing 14 is provided with the second member 40. The middle housing 13 is provided with the first member 30 and the second member 40. A member formed by integrating the first member 30 and the second member 40 serves as a third member 50. That is, the middle housing 13 is provided with the third member 50. In this embodiment, the housing 11 is provided with two first members 30 and two second members 40. Out of these, one first member 30 and one second member 40 are integrated to configure one third member 50.

### First Member, Terminal Accommodating Portions

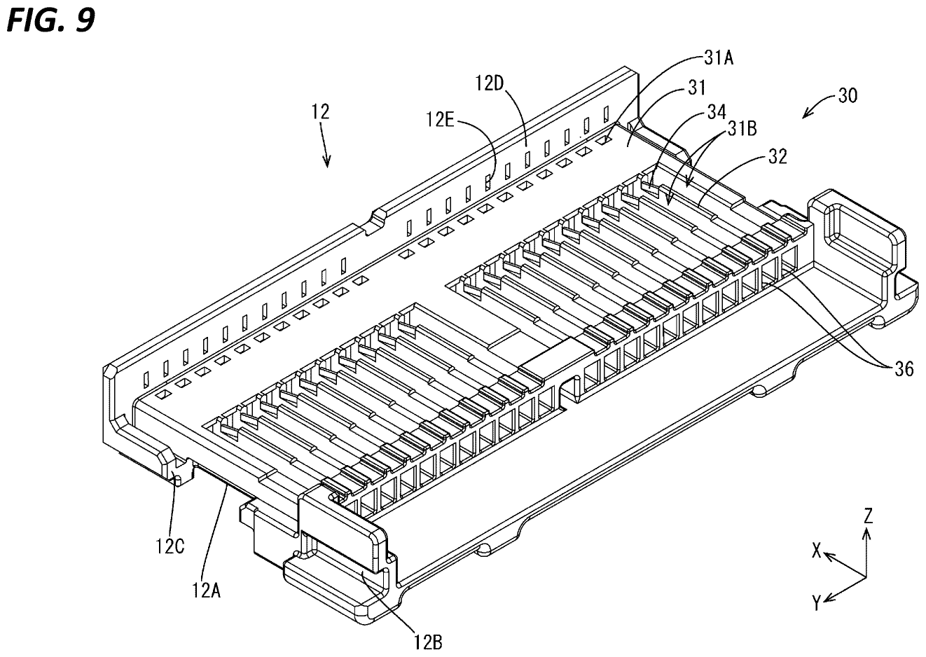

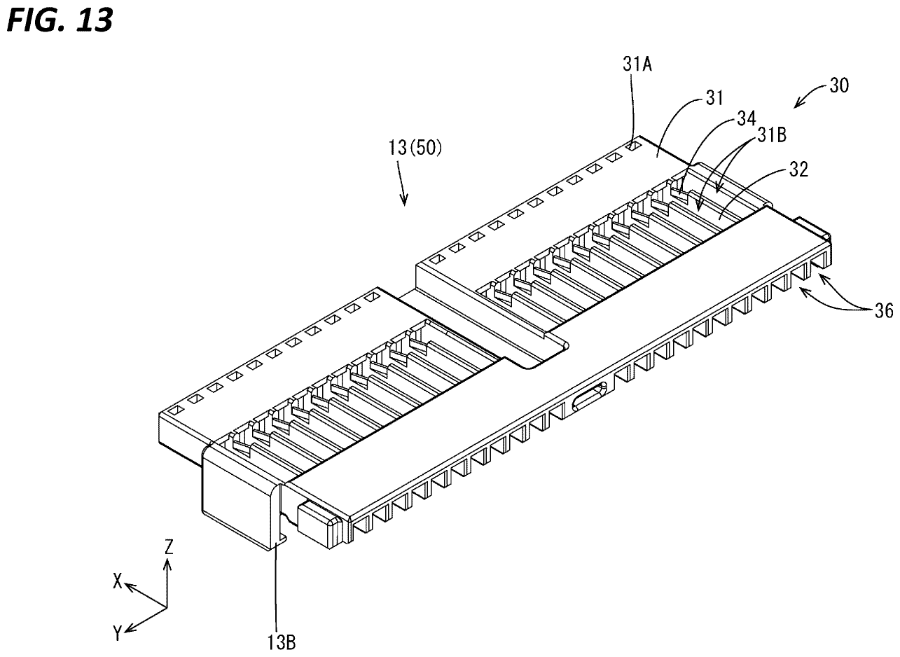

As shown in FIGS. 9 and 13, a plurality of the terminal accommodating portions 31 are provided side by side in a lateral direction (arrangement direction of the terminals 20) in the first member 30. A wire insertion hole 36 communicating with the inside of the terminal accommodating portion 31 is provided behind the terminal accommodating portion 31. An unillustrated wire is inserted into the wire insertion hole 36. The lance hole 31A open in the vertical direction is formed at the position near the front end of the upper wall of the terminal accommodating portion 31. As shown in FIGS. 5 and 6, the inner wall of the lance hole 31A is locked to the locking lance 21B of the terminal 20 accommodated in the terminal accommodating portion 31.

An opening 31B open upward is formed near a central part in the front-rear direction of the terminal accommodating portion 31. A locking projection 42 of the second member 40 to be described later enters the terminal accommodating portion 31 via the opening 31B.

### Protrusions

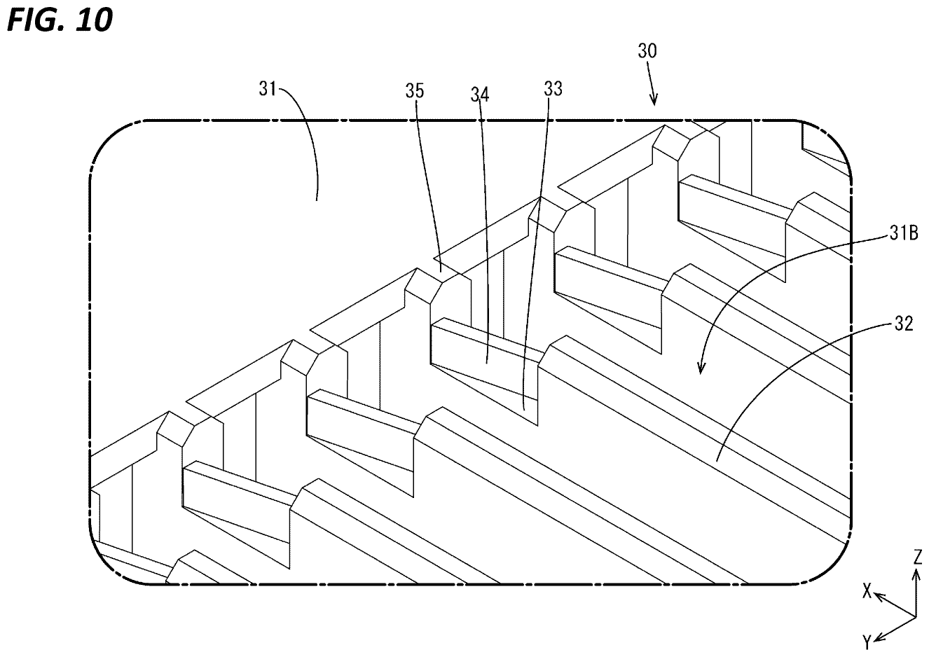

As shown in FIGS. 9 and 13, partition walls 32 are disposed between the terminal accommodating portions 31 adjacent in a lateral direction. The partition wall 32 is one wall portion constituting the opening 31B. As shown in FIG. 10, a coupling portion receiving portion 33 recessed downward from an upper end part of the partition wall 32 is formed at a position near the front end of the partition wall 32. A protrusion 34 rising upward from the bottom wall of the coupling portion receiving portion 33 is formed inside the coupling portion receiving portion 33. The protrusion 34 is plate-like. The protrusion 34 is connected to the front and rear walls of the coupling portion receiving portion 33. A height of the protrusion 34 is about half the height of the coupling portion receiving portion 33. The protrusion 34 extends in a direction inclined to the front-rear direction. That is, the protrusion 34 extends in a direction intersecting the front-rear direction. In particular, the protrusion 34 is inclined to be located more leftward toward the front. A front end part of the partition wall 32 disposed forward of the coupling portion receiving portion 33 serves as a projecting portion 35.

### Second Member, Base Portion

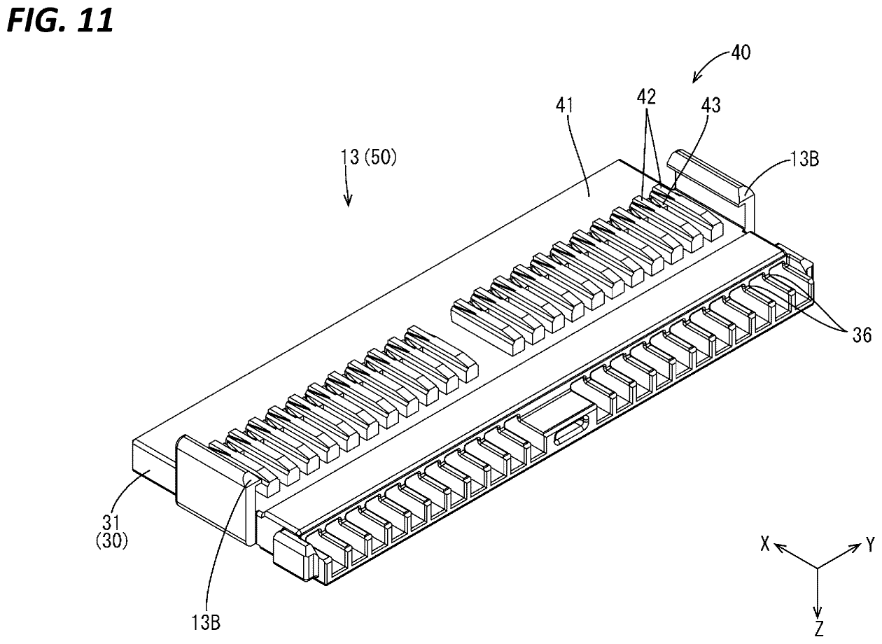

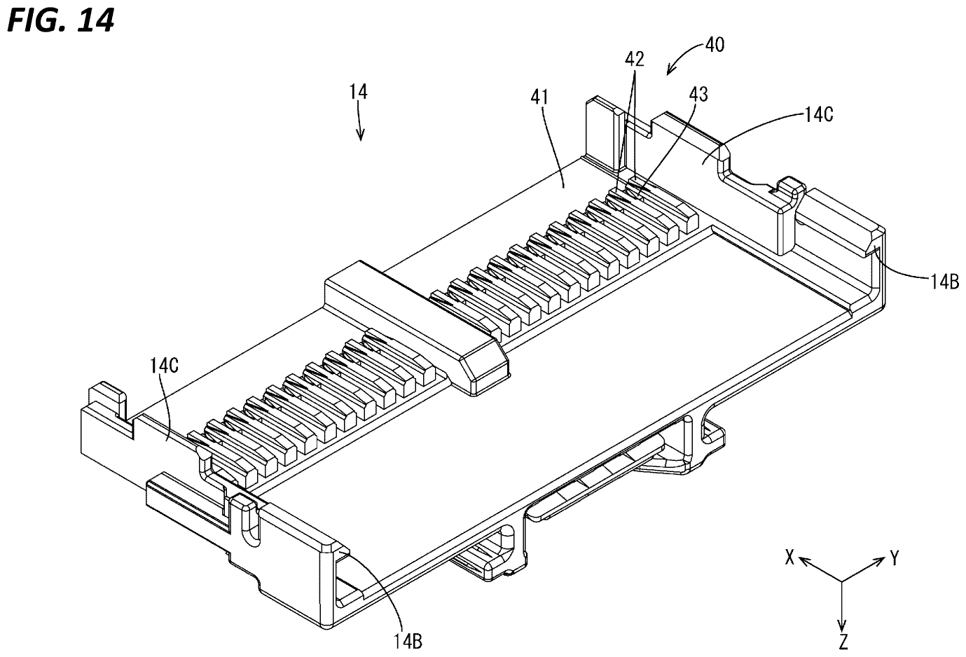

As shown in FIGS. 11 and 14, the second member 40 includes a base portion 41, a plurality of the locking projections 42 projecting downward from the base portion 41 and a plurality of coupling portions 43 coupling the adjacent locking projections 42. The base portion 41 is in the form of a plate flat in the vertical direction. Note that, as shown in FIG. 8, the base portion 41 is disposed below the terminal accommodating portions 31 in the third member 50 (middle housing 13) formed by integrating the first member 30 and the second member 40.

### Locking Projections

As shown in FIGS. 11 and 14, the plurality of locking projections 42 extend in the front-rear direction and are arranged in the lateral direction. As shown in FIGS. 5 and 6, the locking projection 42 enters the terminal accommodating portion 31 through the opening 31B. The locking projection 42 is shaped to extend along the terminal 20 from the rear end of the connecting tube portion 21 to the wire barrel 23A. A lower end part of a front side of the locking projection 42 enters the inside of the neck portion 24. An end surface on the front side of the locking projection 42 serves as a locking surface 42A. The locking surface 42A is locked to the locking portion 22 of the terminal 20 in the front-rear direction.

### Coupling Portions

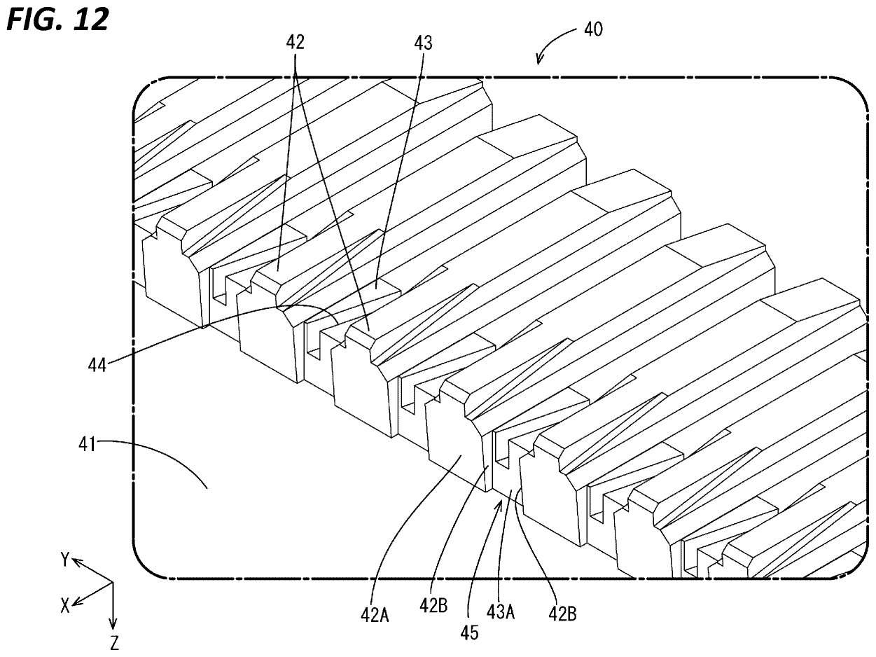

As shown in FIG. 12, the coupling portion 43 is provided to extend downward from the base portion 41. The coupling portion 43 couples parts of the locking projections 42 on the side of the locking surfaces 42A (front side). A dimension in the front-rear direction of the coupling portion 43 is about one-fourth of the dimension in the front-rear direction of the locking projection 42. As shown in FIG. 7, the coupling portion 43 is accommodated into the coupling portion receiving portion 33. As shown in FIG. 8, the coupling portion 43 projects further downward than an upper end part 22A of the locking portion 22.

If a load is applied to the locking projection 42 from the locking portion 42 such as when the terminal 20 is pulled rearward, a part of a material constituting the locking projection 42 escapes laterally (in the arrangement direction of the terminals 20) with respect to the locking portion 22 by being pushed by the locking portion 22. However, since the coupling portion 43 coupling the locking projections 42 is provided to extend further downward than the upper end part 22A of the locking portion 22 in this embodiment, it can be suppressed that a part of the material of the locking projection 42 escapes laterally to the locking portion 22. Thus, a shear area of the locking projection 42 locked to the locking portion 22 is easily ensured and a holding force for holding the terminal 20 can be enhanced as compared to the case where the coupling portion 43 is not provided.

### Groove Portions

As shown in FIG. 12, in this embodiment, the coupling portion 43 is formed with a groove portion 44 recessed upward from the lower surface of the coupling portion 43. The groove portion 44 is provided to extend from the front end to the rear end of the coupling portion 43 and open forward and rearward. The groove portion 44 extends in a direction inclined to the front-rear direction. That is, the groove portion 44 extends in a direction intersecting the front-rear direction. In particular, the groove portion 44 is disposed more leftward toward the front. As shown in FIGS. 6 to 8, the protrusion 34 is accommodated into the groove portion 44.

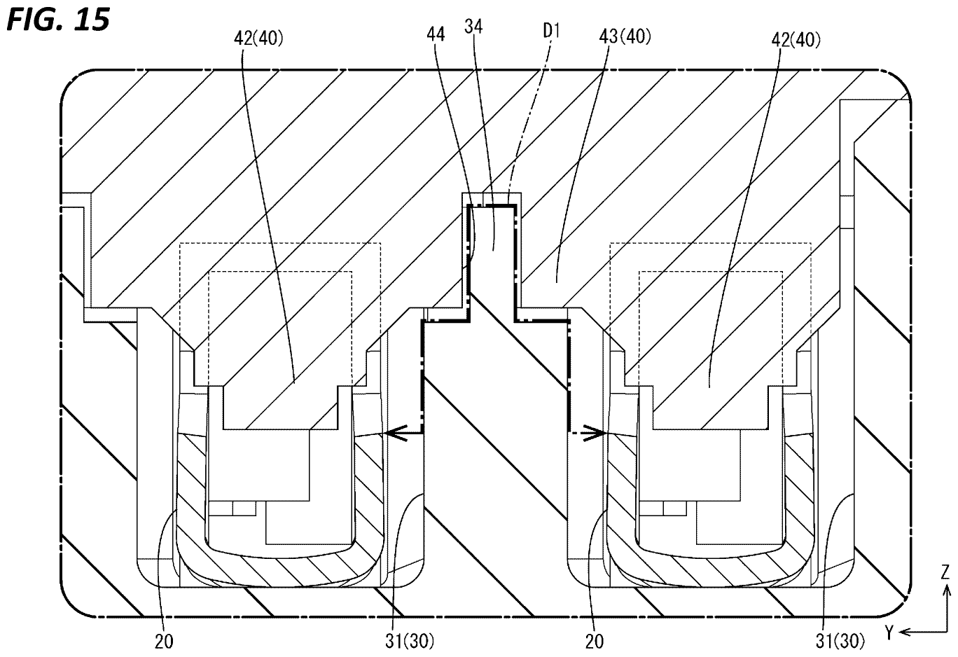

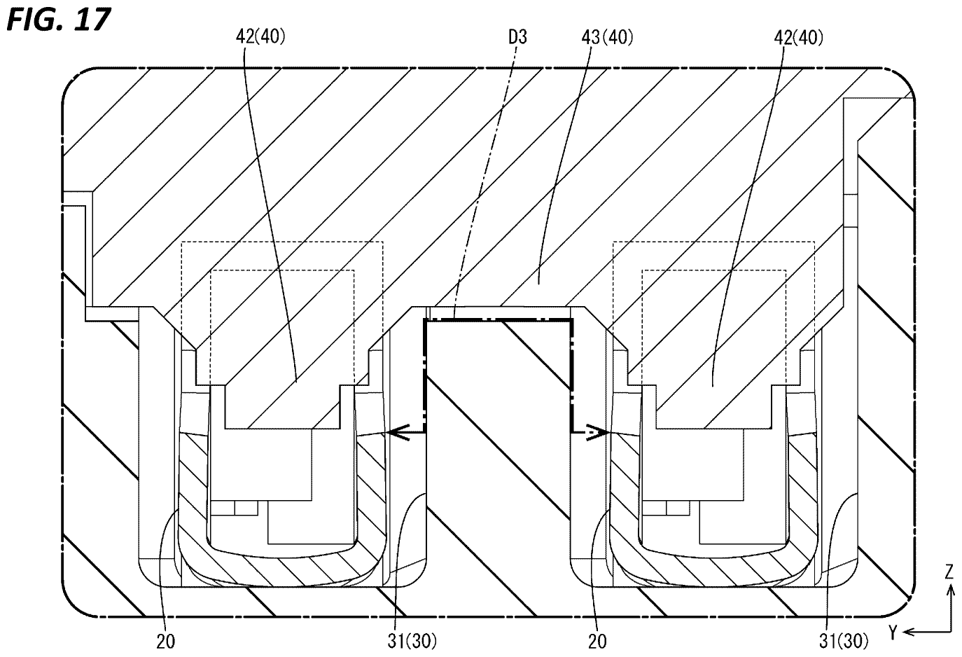

If the coupling portion 43 is not formed with the groove portion 44, a creepage distance D3 between the terminals 20 in the terminal accommodating portions 31 arranged in the lateral direction is indicated by a one-dot chain line of FIG. 17 in a region where the coupling portion 43 is provided. If the terminals 20 and the terminal accommodating portions 31 are reduced in size, it may not be possible to sufficiently ensure the creepage distance 30 between the terminals 20 by providing the coupling portion 43. However, since the groove portion 44 and the protrusion 34 are provided in this embodiment, a creepage distance D1 between the terminals 20 can be longer than the creepage distance D3 shown in FIG. 17 as shown in FIG. 15.

Further, since the groove portion 44 and the protrusion 34 extend in the direction inclined to the front-rear direction as shown in FIG. 7, the inner wall of the groove portion 44 and the protrusion 34 are locked in the front-rear direction. In this way, the first and second members 30, 40 hardly deviate from each other in the front-rear direction.

In this embodiment, the groove portions 44 provided in the respective coupling portions 43 extend in the same direction. In this way, intervals between the groove portions 44 in the lateral direction can be set constant. Thus, as shown in FIG. 8, the sizes of the coupling portions 43 supporting the respective locking projections 42 at a height where the groove portions 44 are provided can be set constant between the plurality of locking projections 42. Therefore, holding forces for holding the terminals 20 by the respective locking projections 42 can be set equal.

### Receiving Spaces

As shown in FIG. 12, the second member 40 of this embodiment includes receiving spaces 45 in front of the coupling portions 43. The receiving space 45 is disposed between the adjacent locking projections 42. The receiving space 45 is defined by the lower surface of the base portion 41, side surfaces 42B of the locking projections 42A and a front surface 43A of the coupling portion 43. By providing the receiving space 45, the front surface 43A of the coupling portion 43 is disposed at a position back from the locking surface 42A of the locking projection 42. A dimension in the front-rear direction of the receiving space 45 is about one-seventh of the dimension in the front-rear direction of the coupling portion 43. As shown in FIG. 7, the projecting portion 35 is disposed in the receiving space 45.

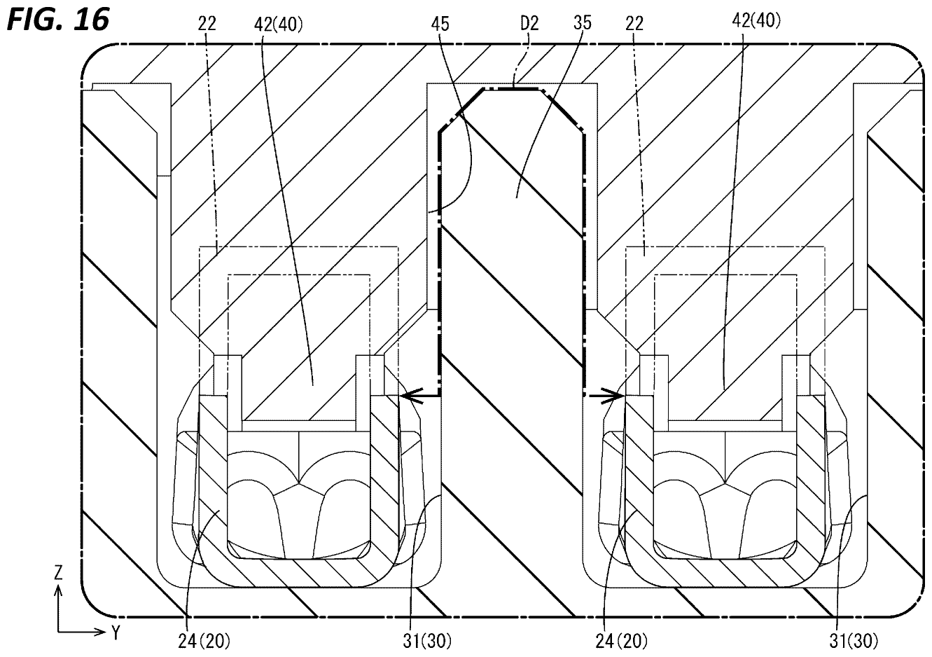

As shown in FIGS. 5 and 6, a height (dimension measured upward from a bottom wall side of the terminal accommodating portion 31) of the terminal 20 is large near the locking surface 42A. Specifically, the locking portion 22 on the rear end of the connecting tube portion 21 is disposed in front of the locking surface 42A. Further, a height of the neck portion 24 is large on the side of the connecting tube portion 21. In this embodiment, the receiving space 45 and the projecting portion 35 are provided in a region near the locking surface 42A as shown in FIG. 7. Therefore, as shown in FIG. 16, a creepage distance D2 between the terminals 20 can be sufficiently ensured in a region near the locking portion 22 of the terminal 20 (i.e. the region near the locking surface 42A) by providing the receiving space 45 and the projecting portion 35.

Further, since the projecting portion 35 is disposed in the receiving space 45 not provided with the coupling portion 43, it can be suppressed by the projecting portion 35 that the material of the locking projection 42 escapes laterally to the locking portion 22.

### Functions and Effects of Embodiment

According to the embodiment, the following functions and effects are achieved.

The stacked connector 10 according to the embodiment is provided with the plurality of terminals 20, at least one first member 30 and at least second member 40 to be stacked on the first member 30 from one side in the first direction (from above). The first member 30 includes the plurality of terminal accommodating portions 31 for accommodating the terminals 20. The second member 40 includes the base portion 41, the plurality of locking projections 42 projecting toward the other side in the first direction (downward) from the base portion 41 and at least one coupling portion 43 coupling the adjacent locking projections 42. The terminal 20 includes the locking portion 22 to be locked to the locking projection 42 from one side in the second direction (from front). The coupling portion 43 projects further toward the other side in the first direction than the end part (upper end part 22A) of the locking portion 22 on the one side in the first direction.

If a load is applied to the locking projection 42 by the locking portion 22 of the terminal 20, the locking projection 42 is deformed and a part of the material of the locking projection 42 escapes in the arrangement direction of the terminals 20 (lateral direction). In the above configuration, the coupling portion 43 coupling the adjacent locking projections 42 is provided and projects further toward the other side in the first direction than the end part of the locking portion 22 on the one side in the first direction. Thus, it is suppressed that a part of the material of the locking projection 42 pushed out by the locking portion 22 escapes in the arrangement direction of the terminals 20. Therefore, a shear area of the locking projection 42 is easily ensured and a holding force for holding the terminal 20 can be enhanced.

In the embodiment, the coupling portion 43 includes the groove portion 44 recessed toward the one side in the first direction from the coupling portion 43, and the first member 30 includes the protrusion 34 to be accommodated into the groove portion 44 by being disposed between the adjacent terminal accommodating portions 31.

According to this configuration, the creepage distance between the terminals 20 can be increased by providing the groove portion 44 in the coupling portion 44 and providing the protrusion 34 on the first member 30.

In the embodiment, the groove portion 44 extends in the direction intersecting the second direction (front-rear direction).

According to this configuration, the first and second members 30, 40 hardly deviate in the second direction by locking the protrusion 34 and the inner wall of the groove portion 44.

In the embodiment, the second member 40 includes the plurality of coupling portions 43, and each coupling portion 43 is provided with the groove portion 44 extending in the same direction.

According to this configuration, intervals between the groove portions 44 in the arrangement direction of the terminals 20 can be set constant. Thus, the sizes of the coupling portions 43 supporting the respective locking projections 42 at the height where the groove portions 44 are provided can be set constant between the plurality of locking projections 42. Therefore, the holding forces for holding the terminals 20 by the respective locking projections 42 can be set equal.

In the embodiment, the second member 40 includes the receiving space 45 between the adjacent locking projections 42, the receiving space 45 is disposed further toward the one side in the second direction than the coupling portion 43, and the first member 30 includes the projecting portion 35 disposed between the adjacent terminal accommodating portions 31 to enter the receiving space 45.

Since the height of the terminal 20 is large near the locking surface 42A where the locking projection 42 is locked to the locking portion 22 of the terminal 20, the creepage distance between the adjacent terminals 20 tends to decrease. According to the above configuration, since the receiving space 45 is disposed further toward the one side in the second direction than the coupling portion 43 and the first member 30 includes the projecting portion 35 configured to enter the receiving space 45, the creepage distance between the terminals 20 is easily ensured also in the region near the locking surface 42A.

In the embodiment, the plurality of first members 30 and the plurality of second members 40 are provided, and at least one third member 50 configured by integrating the first member 30 and the second member 40 is provided.

According to this configuration, since the third member 50 doubles as the first member 30 and the second member 40, the multi-stage stacked connector 10 can be configured.

### OTHER EMBODIMENTS

(1) Although the stacked connector 10 is provided with one third member 50 and the terminals 20 are arranged in two upper and lower stages in the above embodiment, there is no limitation to this and terminals may be arranged in one, three or more stages in a stacked connector.
(2) Although the groove portions 44 are provided in the above embodiment, there is no limitation to this and groove portions may not be provided as shown in FIG. 17.
(3) Although the receiving spaces 45 are provided in the above embodiment, there is no limitation to this and receiving spaces may not be provided.

### LIST OF REFERENCE NUMERALS

10: stacked connector
11: housing
12: lower housing
12A: first lock receiving portion
12B: second lock receiving portion
12C: lock recess
12D: front wall
12E: through hole
13: middle housing
13A: resilient piece
13B: first lock portion
14: upper housing
14A: resilient piece
14B: second lock portion
14C: lock protrusion
20: terminal
21: connecting tube portion
21A: resilient contact piece
21B: locking lance
22: locking portion
22A: upper end part of locking portion
23: wire connecting portion
23A: wire barrel
23B: insulation barrel
24: neck portion
30: first member
31: terminal accommodating portion
31A: lance hole
31B: opening
32: partition wall
33: coupling portion receiving portion
34: protrusion
35: projecting portion
36: wire insertion hole
40: second member
41: base portion
42: locking projection
42A: locking surface
42B: side surface
43: coupling portion
43A: front surface
44: groove portion
45: receiving space
50: third member

1. A stacked connector, comprising:
a plurality of terminals;
at least one first member; and
at least one second member to be stacked on the first member from one side in a first direction,
the first member including a plurality of terminal accommodating portions for accommodating the terminals,
the second member including a base portion, a plurality of locking projections projecting from the base portion toward the other side in the first direction and at least one coupling portion coupling the adjacent locking projections,
the terminal including a locking portion to be locked to the locking projection from one side in a second direction, and
the coupling portion projecting further toward the other side in the first direction than an end part of the locking portion on the one side in the first direction.

2. The stacked connector of claim 1, wherein:
the coupling portion includes a groove portion recessed toward the one side in the first direction from the coupling portion, and
the first member includes a protrusion disposed between the adjacent terminal accommodating portions and to be accommodated into the groove portion.

3. The stacked connector of claim 2, wherein the groove portion extends in a direction intersecting the second direction.

4. The stacked connector of claim 3, wherein:
the second member includes a plurality of the coupling portions, and
each coupling portion is provided with the groove portion extending in the same direction.

5. The stacked connector of claim 1, wherein:
the second member includes a receiving space between the adjacent locking projections,
the receiving space is disposed further toward the one side in the second direction than the coupling portion, and
the first member includes a projecting portion disposed between the adjacent terminal accommodating portions to enter the receiving space.

6. The stacked connector of claim 1, wherein:
a plurality of the first members and a plurality of the second members are provided,
at least one third member configured by integrating the first member and the second member is provided.
